(19) United States
(12) Patent Application Publication
(10) Pub. No.: US 2026/0346473 A1
(43) Pub. Date: Nov. 5, 2026

(54) UNDERACTUATED HAND WITH CABLE-DRIVEN FINGERS

(71) Applicant: Tesla, Inc., Austin, TX (US)

(72) Inventor: Michael LEDDY, Austin, TX (US)

(73) Assignee: Tesla, Inc., Austin, TX (US)

(21) Appl. No.: 19/113,898

(22) PCT Filed: Oct. 2, 2023
(86) PCT No.: PCT/US2023/034306

§ 371 Date: Mar. 20, 2025

Related U.S. Application Data
(60) Provisional application No. 63/378,034, filed on Sep. 30, 2022.
(60) Provisional application No. 63/377,919, filed on Sep. 30, 2022.

(51) Int. Cl. B25J 15/00; B25J 9/10; B25J 13/08; B25J 15/02

(52) U.S. Cl. CPC B25J 15/0009; B25J 9/106; B25J 13/088; B25J 15/0233

(57) ABSTRACT

A robotic hand system can comprise a palm region and one or more fingers, each finger comprising an actuator device; a proximal member having a first end mechanically coupled to the palm region robot and configured to rotate around a first pivot relative to the palm region; a distal member having a first end mechanically coupled to a second end of the proximal member and configured to rotate around a second pivot relative to the proximal member; and a cable having a first portion coupled to the actuator and a second portion extending along the proximal member and the distal member, the second portion separated away from the first pivot and the second pivot and having an end with a higher dimension than a diameter of the cable, the end with higher dimension structured to engage the distal member when the cable is pulled by the actuator.

### CROSS-REFERENCE TO RELATED PATENT APPLICATIONS

The present application claims priority to U.S. Provisional Application No. 63/377,919, filed Sep. 30, 2022, and claims priority to U.S. Provisional Application No. 63/378,034, filed Sep. 30, 2022, both applications are incorporated by reference in their entirety for all purposes.

### TECHNICAL FIELD

The present disclosure generally relates to underactuated hands with cable-driven fingers. In particular, the current disclosure relates to cable-driven robot hands and fingers with adaptive grasp and an optimization framework for optimizing various design parameters of the cable-driven robot hands and fingers.

### BACKGROUND

A robot can be viewed as a chain or collections of joints, which enable desired motions of the robot. Each joint enables adjacent structures or elements to move relative to one another. The motion of the adjacent elements is driven by one or more actuators associated with the joint. A computer system controls the actuator(s) to achieve the desired motion(s).

The design of a joint defines the range of motion of the corresponding adjacent elements. Also, the joint design can affect the number and/or type(s) of actuators to be used as well as the efficiency of the actuator(s).

### SUMMARY

For various reasons, the hand and fingers are among the components of a robot that present very complex and difficult technical challenges when it comes to design and optimization of the design parameters. One first challenge is how to achieve an adaptive and stable grasp of objects. Adaptability relates to the capability of the fingers or respective joints to adapt their position and/or motion based on the place and characteristics of contact with another object. Stability refers to getting a good grasp of the object in a way the object does not slip or fall. A second technical challenge is the transmission or how forces or torques are transmitted to different links or members of a finger. Another technical challenge is how to optimize or enhance the efficiency of the forces applied to the abject. These and other technical challenges make the design of a robot hand and fingers a complex multi-dimensional problem and call for novel techniques to get closer to characteristics or capabilities of a human hand.

In the current disclosure, systems and methods for a robot hand and cable-driven fingers configured to mimic human hands and fingers are described. In particular, the systems and method described herein provide a novel routing of cables in cable-driven fingers to enable more adaptive, stable and efficient grasping of objects. The cable routing described herein leads to different transmission patterns of force and/or torque to various links or structures of the fingers and enables a range of motion and/or positions that mimic to some extent the motion or positions of human fingers. The fingers described herein are underactuated with a single actuator driving two joints of a finger.

Systems and methods described in the current disclosure also provide optimization and simulation frameworks to achieve enhanced adaptability, stability, and efficiency, especially with respect to grabbing an object by the hand and fingers described herein. Specifically, the optimization and simulation frameworks enable optimization of various parameters of the finger designs or finger systems described herein.

According to at least one aspect, a robotic hand system can comprise a palm region and one or more fingers, each finger comprising an actuator device; a respective proximal member having a first end mechanically coupled to the palm region robot and configured to rotate around a respective first pivot relative to the palm region; a respective distal member having a first end mechanically coupled to a second end of the proximal member and configured to rotate around a respective second pivot relative to the proximal member; and a respective cable having a first portion coupled to the actuator and a second portion extending along the proximal member and the distal member, the second portion separated away from the first pivot and the second pivot and having an end with a higher dimension than a diameter of the cable, the end with higher dimension structured to engage the distal member when the cable is pulled by the actuator.

The end with higher dimension may be floating within a region of the distal member. In some implementations, the end with higher dimension includes at least one of a potted end or an end with a potted insert.

Each finger may comprise a respective channel structure extending at least partially along the respective proximal member and the respective distal member, the respective channel structure hosting at least partially the second portion of the respective cable.

The end with higher dimension of the second portion of the respective cable may be structured to engage a ledge structure of the respective channel structure when the respective cable is pulled by the respective actuator.

Each finger may comprise a respective first torsion spring placed around the respective first pivot; and a respective second torsion spring placed around the respective second pivot.

Each finger may comprise a respective magnet coupled to the respective first pivot; and a respective hall effect sensor placed proximate to the respective magnet. In some implementations, the respective magnet includes a ring magnet placed around the respective first pivot.

Each finger may comprise a respective magnet coupled to the respective second pivot; and a respective hall effect sensor placed proximate to the respective magnet.

A distance between the respective cable and the respective first pivot may vary and/or a distance between the respective cable and the respective second pivot may vary.

According to at least one aspect, a finger device can comprise an actuator device; a proximal member having a first end mechanically coupled to base member and configured to rotate around a first pivot relative to the base member; a distal member having a first end mechanically coupled to a second end of the proximal member and configured to rotate around a second pivot relative to the proximal member; and a cable having a first portion coupled to the actuator and a second portion extending along the proximal member and the distal member, the second portion separated away from the first pivot and the second pivot and having an end with a higher dimension than a diameter of the cable, the end with higher dimension structured to engage the distal member when the cable is pulled by the actuator.

The end with higher dimension may be floating within a region of the distal member.

The end with higher dimension may include at least one of a potted end; or an end with a potted insert.

The finger device may comprise a channel structure extending at least partially along the proximal member and the distal member, the channel structure hosting at least partially the second portion of the cable.

The end with higher dimension of the second portion of the cable may be structured to engage a ledge structure of the channel structure when the respective cable is pulled by the respective actuator.

The finger device may further comprise: a first torsion spring placed around the first pivot; and a second torsion spring placed around the second pivot.

The finger device may further comprise a magnet coupled to the first pivot; and a hall effect sensor placed proximate to the magnet. In some implementations, the magnet includes a ring magnet placed around the first pivot.

In some implementations, the finger device system further comprises: a magnet coupled to the second pivot; and a hall effect sensor placed proximate to the magnet.

A distance between the cable and the first pivot may vary and/or a distance between the cable and the second pivot may vary.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1 illustrates a diagram of an example humanoid robot where systems and methods described herein can be integrated, according to an embodiment.

FIG. 2 illustrates a front view of a robot hand, according to an embodiment.

FIGS. 3A-3C illustrate various partially transparent views of the hand of FIG. 2, according to an embodiment.

FIGS. 4A-4F show various views of a cable-driven finger (or finger device), according to an embodiment.

FIGS. 5A and 5B show internal views of another finger (or finger system), according to an embodiment.

FIGS. 6A-6G, motion simulated results for a system including two fingers are shown, according to an embodiment.

FIGS. 7A-7C show diagrams of a gearbox, according to an embodiment.

FIGS. 8A and 8B depict the use of hall effect sensors to monitor the position of a finger or the corresponding members, according to an embodiment.

FIG. 9 shows a framework for optimizing the parameters of cable-driven finger, according to an embodiment.

FIGS. 10A-10B show an optimization model and a simulation od an optimized hand model, according to an embodiment.

FIGS. 11A-11C show simulation results depicting effective lever arms, a feasible force range, a contact vector field, and energy loss, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

In the current disclosure systems devices and methods for robotic hands and cable-driven fingers are described. The robotic hands and cable-driven fingers described herein enable adaptive and stable finger motion. Adaptability refers to the motion of finger links being adaptive to points of contact or points of forces of contact. Also, robotic hands and cable-driven fingers described herein enable more stable and more efficient grasping of objects. The robotic hands and cable-driven fingers described herein mimic at least some extent the human hand and fingers.

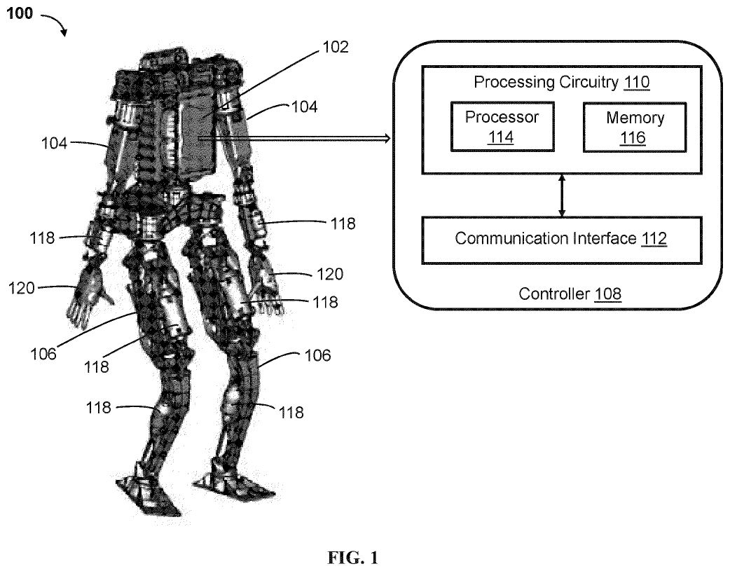

FIG. 1 is a diagram of an example humanoid robot 100 where the systems and methods described herein can be integrated, according to an example embodiment. The humanoid robot 100 can include an upper body 102, two arms 104 and two legs 106. The upper body 102 can include a controller 108 for controlling the robot 100. The controller 108 can include a processing circuitry 110 and a communication interface 112. The processing circuitry 110 can be communicatively coupled to the communication interface 112. The processing circuitry 110 can include a processor 114 and a memory 116. The robot 100 can include a plurality of actuators 118 associated with a plurality of joints. Each arm 104 can include a corresponding hand 120. The robot 100 may include one or more sensors for sensing parameters of the robot 100 or the surrounding of robot 100. The robot 100 may include one or more cameras.

The processor 114 may be implemented as a single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. The processor 114 may be a microprocessor. The processor 114 also may be implemented as a combination of computing devices, such as a combination of a DSP and a microprocessor, a plurality of microprocessors, one or more microprocessors in conjunction with a DSP core, or any other such configuration. In some implementations, the controller 108 may include one or more processors 114.

The memory 116 (e.g., memory unit and/or storage device) may include one or more devices (e.g., RAM, ROM, Flash memory, hard disk storage) for storing data and/or computer code for completing or facilitating the various processes described in the present disclosure. The memory 116 may be communicably connected to the processor 114 to provide computer code or instructions to the processor 114 for executing at least some of the processes described herein. Moreover, the memory 116 may be or include tangible, non-transient volatile memory or non-volatile memory. For instance, the memory 116 may include database components, object code components, script components, or any other type of information structure for supporting the various activities and information structures described herein.

The communications interface 112 may include any combination of wired and/or wireless interfaces (e.g., jacks, antennas, transmitters, receivers, transceivers, wire terminals) for conducting data communications with various systems or devices of the robot 100. For instance, the communications interface 112 can enable communications between the processing circuitry 110 (or the processor 114) and the actuators 118, sensors or cameras integrated into the robot 100. In some implementations, the communications interface 112 can enable communications with remote systems or devices.

The processing circuitry 110 or the processor 114 can be configured to control joints of the robot 100. The processing circuitry 110 or the processor 114 can control a joint or movements associated with the joint by controlling the corresponding actuator(s) 118. In particular, each joint can include or can be associated with one or more actuators 118 configured to drive motion of robot components or elements connected via the joint. As discussed in further detail below, the processing circuitry 110 or the processor 114 can send instructions to the actuator(s) 118 to cause or trigger precise motion of one or more elements or components of the robot 100. The processing circuitry 110 or the processor 114 can control multiple joints simultaneously to achieve a coordinated movement of the robot 100.

The processing circuitry 110 or the processor 114 can receive data from sensors and/or cameras integrated in the robot 100, and make decisions, e.g., with regard to which elements of the robot 100 to move and how, based on the received data. For example, the data received from the sensors and/or cameras can be indicative of an obstacle in the path of the robot 100. The processing circuitry 110 or the processor 114 can decide to modify the path and determine movements of one or more limbs or components of the robot 100 based on the modified path. In some implementations, the processing circuitry 110 or the processor 114 can receive data from a remote device or system indicative of a task to be performed by the robot 100 and determine a sequence of movements of the limbs or components of the robot 100 to perform the task.

While FIG. 1 shows the controller as being integrated in the chest or upper body of the robot 100, in general, the controller 108 can be placed or integrated in other regions or parts of the robot 100. For example, the robot 100 can include a head and the controller 108 can be integrated into or on the head. In some implementations, the controller 108 can be placed on the back, in or on the waist region and/or in or on one of the limbs of the robot 100.

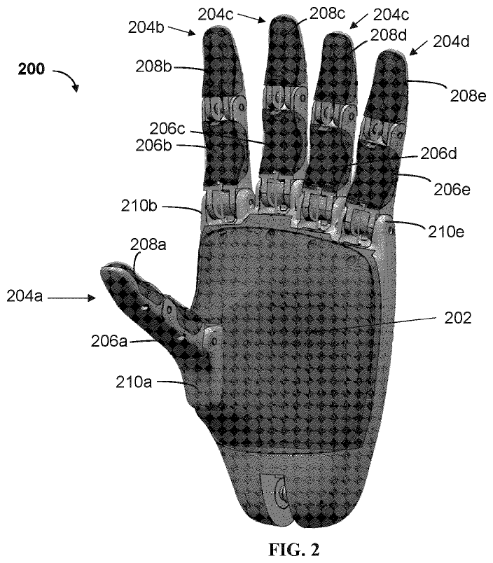

FIG. 2 illustrates a front view of a robot hand 200, according to an embodiment. The hand 200 can include a palm region 202 and a plurality of fingers, such as fingers 204a-204e, which are also referred to herein individually or collectively as finger(s) 204. The hand 200 is similar in structure to a human hand with a thumb finger 204a and four forefingers 204b-204e. Each of the fingers 204a-204e can include a respective proximal member, e.g., among the proximal members 206a-206e, and a respective distal member, e.g., among the distal members 2081-208e.

The proximal members 206a-206e are also referred to herein as proximal member(s) 206 or proximal link(s) 206. The distal members 208a-208e are also referred to herein as distal member(s) 206 or distal link(s) 204. As described in further detail below, each proximal member 206 can be configured or structured to rotate relative to the palm region 202, e.g., around a corresponding first pivot coupling the proximal member 206 to the palm region. Also, each distal member 208 can be configured or structured to rotate relative to the corresponding proximal member 206, e.g., around a corresponding second pivot coupling the distal member 208 to the corresponding proximal member 206.

In some implementations, each of the fingers 204a-204e (or a subset thereof) can include a respective base member, e.g., among the base members 210a-210e. The base members 210a-210e are also referred to herein as base member(s) 210 or base link(s) 210. Each base member 210 can be mechanically fixed to the palm region 202 and mechanically coupled to the corresponding proximal member 206 in the same finger 204. For instance, each proximal member 204 can be mechanically coupled to the corresponding base member 210 via the corresponding first pivot. Each proximal member 206 can be configured or structured to rotate relative to the corresponding base member 210, e.g., around the corresponding first pivot.

Each of the fingers 204 can be actuated independently of other fingers 204. The hand (or hand device) 200 as shown in FIG. 2 is an anthropomorphic hand structured to mimic the human hand. In particular, the hand 200 includes a thumb finger 204 and four forefingers 204b-204e. It is to be noted however that the systems described herein can be employed in other types of robot hands having any number of fingers 204. For instance, the systems and methods described herein can integrated or employed in single-finger robot hands or multi-finger robot hands. More generally, the systems and methods described herein can be used or integrated in other components of a robot, e.g., other than the fingers and/or hands.

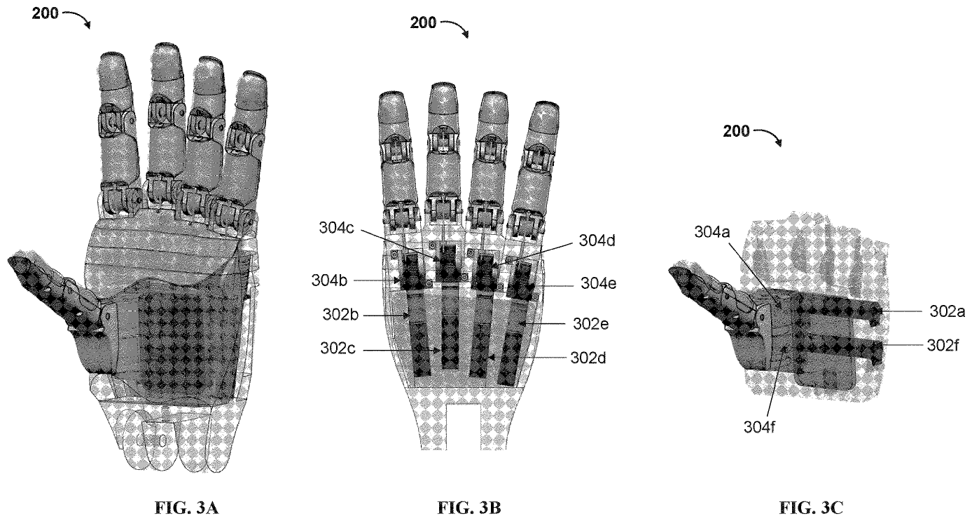

FIGS. 3A-3C illustrate various partially transparent views of the hand 200 of FIG. 2, according to an embodiment. FIG. 3A shows a front view of the hand 200 with the palm region 202 partially transparent. FIG. 3B shows the hand 200 without the thumb finger 204a and with the palm region transparent. FIG. 3C shows the hand 200 with the thumb finger 204a but not the forefingers 204b-204e and with the palm region transparent.

The hand 200 can include six actuators 302a-302f. Each of the forefingers 204b-204e can include or can be associated with a corresponding actuator 302b-302e. For instance, actuator 302b can actuate motion of the proximal member 206b and the distal member 208b of finger 204b, actuator 302c can actuate motion of the proximal member 206c and the distal member 208c of finger 204c, actuator 302d can actuate motion of the proximal member 206d and the distal member 208d of finger 204d, and actuator 302e can actuate motion of the proximal member 206e and the distal member 208e of finger 204e. Each of the actuators 302b-302e can be placed or integrated in the palm region 202 and can be aligned or substantially with the corresponding finger 204. More generally, the actuators 302b-302e can be arranged or placed in the palm region 202 along a longitudinal direction of the hand 200 and/or fingers 204.

Each of the actuator 302b-302e can be viewed as being part of the corresponding finger (or finger device) 204. For instance, finger (or finger device) 204b can include the corresponding actuator 302b, finger (or finger device) 204c can include the corresponding actuator 302c, finger (or finger device) 204d can include the corresponding actuator 302d and finger (or finger device) 204e can include the corresponding actuator 302e. Each of the actuators 302b-302e can include a corresponding gearbox, e.g., among the gearboxes 304b-304e. For instance, actuator 302b can include gearbox 304b, actuator 302c can include gearbox 304c, actuator 302c can include gearbox 304d and actuator 302e can include gearbox 304e.

Referring now to FIG. 3C, the thumb finger 204a can include or can be associated with two actuators 302a and 302f. Actuator 302a can be a thumb drive actuator similar to the actuators 302b-302e. In other words, actuator 302a can be configured or structured to cause movement of the proximal member 206a and distal member 308a in a similar way as actuators 302b-302e do with respect to the corresponding proximal members 206b-206e and distal members 208b-208e, respectively. Actuator 302f can be an abduction/Adduction (Ab/Ad) actuator configured or structured to cause abduction and adduction movements of the thumb. In some implementations, the actuators 302a and 302f can be arranged or integrated in the palm region and can be horizontally or substantially perpendicular to the longitudinal direction of the hand 200 or the forefingers 204b-204e. Actuator 302a can include a gearbox 304a and actuator 302f can include a gearbox 304f.

Each of the actuators 302a-302f can be referred to herein individually or collectively as actuator(s) 302. Also, gearboxes 304a-304f can be referred to herein individually or collectively as gearbox(es) 304. The actuators 302 and gearboxes 304 are described in further detail below.

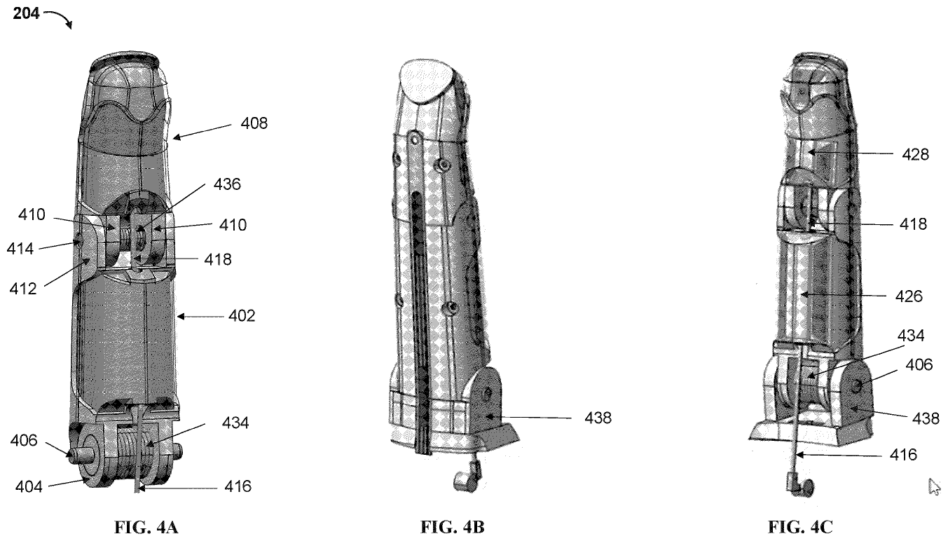

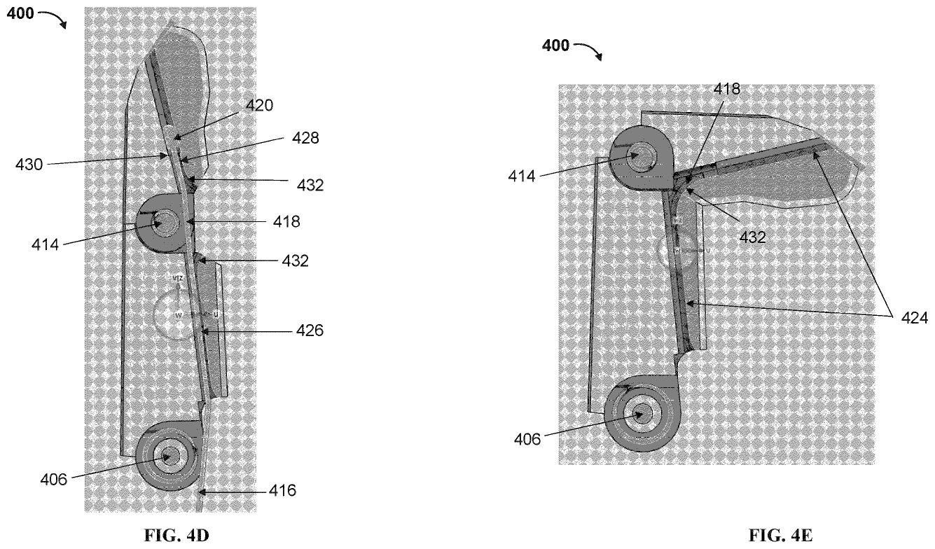

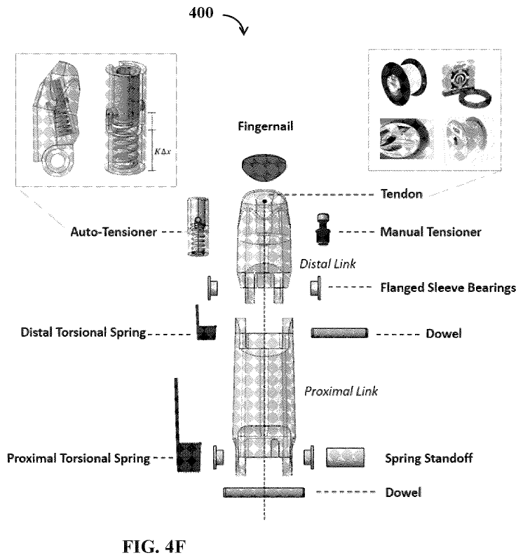

Referring now to FIGS. 4A-4F, various views of a cable-driven finger (or finger device) 400 are shown, according to an embodiment. FIGS. 4A and 4C represent front pictorial views of the finger 400 in straight position and FIG. 4B represents a rear pictorial view of the finger 400 in straight position. FIG. 4D depicts a side view of the finger 400 in straight position and FIG. 4E depicts a side view of the finger 400 in bent position. FIG. 4F depicts an exploded view of the finger 400, according to an embodiment.

Referring to FIGS. 4A-4C, the finger 400 can include a proximal member 402 having a first end 404 that is mechanically coupled to the palm region 202 and configured to rotate around a first pivot 406 relative to the palm region 202. The first pivot 406 can be referred to herein as a pivot structure and can include a pin, a dowel or some other coupling structure that would enable rotation of the proximal member 402. The finger 400 can include a distal member 408 having a first end 410 mechanically coupled to a second end 412 of the proximal member 402 and configured to rotate around a second pivot 414 relative to the proximal member 402. The second pivot 414 can be referred to herein as a pivot structure and can include a pin, a dowel or some other coupling structure that would enable rotation of distal member 408 relative to the proximal member 402.

The finger 400 can include a cable 416 that is coupled (or mechanically coupled) to an actuator 302. A first end or first portion of the cable 416 can be coupled to the actuator 302 and a second portion 418. In some implementations, a first portion of the cable 416 can be wrapped around a pulley of the actuator 302 or of the corresponding gearbox 304. The cable 416 can include a second portion 418 extending or floating along the proximal member 402 and the distal member 408. For instance, the second portion 418 can be free to move along the finger 400 when the cable 416 is actuated (e.g., pulled) by the actuator 302. In some implementations, the cable 416 or the second portion 418 may not be pinned or fixed at any location to the proximal member 402 and may not be pinned or fixed at any location to the distal member 408.

The cable 416 or the second portion 418 can be routed along the proximal member and the distal member 408 in a way to be separated away from the first pivot 406 and the second pivot 414. In other words, the cable 416 or the second portion 418 may not be wrapped around the first pivot 406 and may not be wrapped the second pivot 414. For instance, the cable 416 or the second portion 418 can be routed towards (or closer) the front of the finger 400 relative to the first pivot 406 and may not be wrapped around the second pivot 414. In particular, when the route or path of the cable 416 or the second portion 418 may not pass around the first pivot 406 and may not be pass around the second pivot 414, especially when the proximal member 402 rotates around the first pivot 406 and/or the distal member 408 rotates around the second pivot 414.

Referring to FIGS. 4D and 4E, an end 420 of the cable 416 or of the second portion 418 can be associated with or having a larger dimension (e.g., thickness or diameter) than a diameter of the cable 416. The end 420 associated with or having the larger dimension can be located in or at the distal member 408 and can be structured to engage the distal member 408 when the cable 416 is pulled by the actuator 302. For example, the end 420 can include a potted end, an end with a potted insert or an end coupled to a knob or other structure having a larger dimension than the diameter of the cable 416. When the cable 416 is pulled by the actuator 302, the end 420 can engage the distal member 408 or a structure thereof to cause movement of at least one of the proximal member 402 or the distal member 408. For example, when the cable 416 is pulled by the actuator 302, the end 420 can engage the distal member 408 or a structure thereof causing the proximal member 402 to rotate around the first pivot 406 and/or the distal member 408 to rotate around the second pivot 414.

In some implementations, the finger 400 can include a channel structure 424 extending at least partially along the proximal member 402 and the distal member 408. The channel structure can receive or host, at least partially, the second portion 418 of the cable 416. In some implementations, the channel structure 424 can include one or more groves, troughs, or tubes. The channel structure 424 can provide a conduit to the cable 416 or the second portion 418 to move back and forth along the finger 400 when actuated by the actuator 302. In some implementations, and as shown in FIGS. 4D and 4E, the channel structure 424 can include a first channel portion 426 located in or at the proximal member 402 and a second channel portion 428 located in or at the distal member 408. In other words, the channel structure 424 can be discontinuous around the joint between the proximal member 402 and the distal member 408.

In some implementations, the second channel portion 428 located in or at the distal member 408 can include a ledge structure 430. The end 420 (of the cable 416 or the second portion 418) associated with or having the larger dimension can be structured to engage the ledge structure 430 of the second channel portion 428 located at the distal member 408 when the cable 416 is pulled by the actuator 302. In some implementations, the end 420 (of the cable 416 or the second portion 418) associated with or having the larger dimension can be structured to engage an end of the second channel portion 428 (or of the channel structure 424) located at the distal member 408 when the cable 416 is pulled by the actuator 302.

In some implementations, the end 420 of the cable (or the second portion 418) can be floating in the second channel portion 428 (or in the channel structure 424). In other words, the end 420 of the cable (or the second portion 418) may not be connected of fixed to the distal member 408. In some implementations, the end 420 of the cable 416 (or the second portion 418) can be floating in a pocket or space located within the distal member 408. For example, the pocket or space can be located at the end of the distal member 408 beyond the second channel portion 428 (or the channel structure 424).

In some implementations and as shown in FIGS. 4D and 4E, the proximal member 402 and the distal member 408 can structured to form a convex curved surface 432, e.g., between the first channel portion 426 and the second channel portion 428, to enable or cause the cable 416 to bend according to a predefined radius when the finger 400 bends or when the distal member 408 rotates around the pivot 414. Cables usually have small bending radii, which may cause them to break when bending. By causing the cable 416 to bend according to a relatively larger radius, e.g., larger than the typical bending radius of the cable 416, breaking of the cable 416 can be avoided, which implies improved cable stability. Part of the convex curved surface 432 can in the proximal member 402 and another part can be in the distal member 408.

Referring back to FIGS. 4A-4C, the finger 400 can include a first torsion spring 434 placed around or at the first pivot 406 and a second torsion spring 436 placed around or at the second pivot 414. The first torsion spring 434 can be structured or configured to create some stiffness at the joint between the proximal member 402 and the palm region 202 and the second torsion spring 436 can be structured or configured to create some stiffness at the joint between the proximal member 402 and the distal member 408. The stiffness at the joints or at pivots 406 and 414 contributes to the stability of finger system 400.

In some implementations, the finger (or finger system) 400 can include a base member 438. The base member 438 can be fixed to the palm region 202. The proximal member 402 can be coupled to the palm region 202 via the base member 438. For instance, the proximal member 402 can be coupled to the base member 438 via the pivot 406 and can be structured to rotate around the pivot 406 relative to the base member 438.

FIG. 4F shows an exploded view of the finger (or finger system) 400, according to an embodiment. Each of the pivots 406 and 414 can include a dowel. The torsion spring 436 (referred to in FIG. 4F as distal torsional spring) can be placed on the dowel, and the dowel can be fixed to the distal member (or distal link) 408 and/or the proximal member (or proximal link) 402 via bearings. The torsion spring 434 (referred to in FIG. 4F as proximal torsional spring) can be larger than (e.g., having a larger diameter than) the torsion spring 436 and may have larger stiffness than torsion spring 436. A spring standoff can be placed on the dowel to hold the torsion spring 434, and the spring standoff can be fixed to the distal member (or distal link) 408 and/or the proximal member (or proximal link) 402 via bearings.

The cable 416 is referred to as tendon in FIG. 4F. The end of 420 of the cable 416 located in the distal member 408 can be attached or connected to a manual tensioner to engage the distal member 408 when the cable 416 is actuated by the actuator 302. The manual tensioner can float within an auto-tensioner (having a spring). The auto-tensioner can be arranged in a pocket or space of the distal member 408 at the end of the channel structure 424.

In some implementations and as shown in FIGS. 4D-4F, the channel portion 428 hosting the floating end 420 of the cable 416 can be at an angle relative or with respect to a back surface of the finger 400.

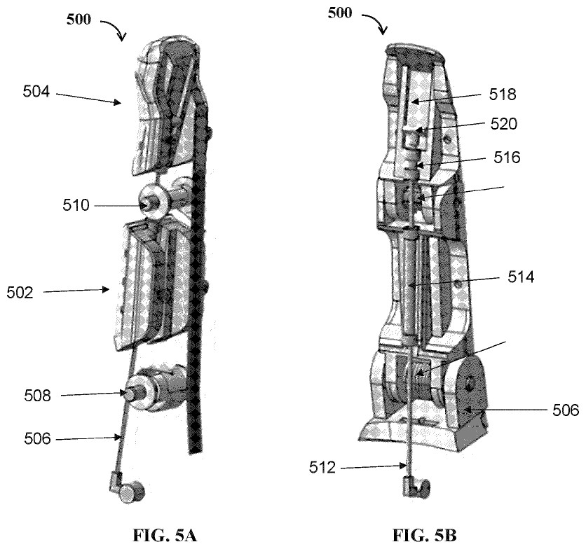

Referring now to FIGS. 5A and 5B, internal views of another finger (or finger system) 500 are shown according to an embodiment. Similar to the finger 400, finger 500 can include a proximal member 502 and a distal member 502. The finger 500 may also include a base member 506. The distal member 502 can be structured or configured to rotate around a pivot 506 relative to the base member 506 or relative to a palm region 202. The distal member 504 can be configured to rotate around a pivot 510 relative to the proximal member. The finger 500 can include a cable 512 connected to actuator 302 at first end and can include a second end placed in the distal region 504. The cable 512 or a part thereof can extend along the proximal region 502 and the distal region 505 and can be separated away from the pivots 508 and 510.

The finger 500 can include one or more tubes, e.g., tubes 514 and 516, forming a channel that partially hosts or receives cable 512. The second end of the cable 512 can be floating (not connected, fastened, or fixed) in a region (or pocket region) 518 of the distal member 504. The second end of the cable 512 can have a potted insert 520 that is structured to engage an end of the pocket region 518 when the cable 512 is pulled by the actuator 302.

The fingers (or finger systems) 400 and 500 or mechanisms thereof can be used or integrated in hand 200 of FIG. 2. Any of the fingers 204a-204e of FIG. 2 can be implemented as finger 400 or finger 500. It is to be noted that features described in different figures or embodiments can be combined in a single embodiment. For example, the pocket region 518 of finger 500 can be implemented in finger 400. Also, the potted insert 520 may be integrated in finger 400 of FIG. 4.

The routing of the cable 416, 512 discussed in relation with FIGS. 4A-4F and 5A-5B has multiple technical advantages over conventional cable driven systems. Specifically, conventional cable-driven fingers wrap the cable 416 around the pivots 406 and 414. The cable 416 can include a metal cable and metal cables have a fixed bend radius. In conventional systems, the cable 416 would be wrapped around the pivots at the joints to keep it at a constant radius when it bends and avoid breaking the cable because these cables have really small bend radiances. However, wrapping the cable 416 around the pivots 406 and 414 limits the range of motion of the finger (or the range in of motion of the proximal member 402 and the distal member 408).

The cable routing described in FIGS. 4A-4F and 5A-5B enables a lot more force to be applied, especially as the angle between the proximal member 402 and the distal member 408 decreases. The amount of force that is applied is actually a function of how far the cable 416 is from the joint. As the cable 416 gets separated further away from the joint, more force can be applied as the hand 200 closes, which allows to fine tune the torque graph in space. The cable routing described herein (not wrapped around the pivots) also helps produce a more equal joint torque and helps fine tune the torque instead of fine tuning the gearbox as usually done in conventional systems. Fine tuning the gearbox causes various issues such as using non-concentric and/or asymmetric gears that makes the design more complex. By fine tuning the torque using the structure of the finger (e.g., the cable location relative to joints, the lengths of the finger members and/or other parameters) instead of fine tuning the gearbox leads to a reduction in parts count and reducing part complexity.

Another advantage of the described cable routing is the fact that two joints of the finger 400 are driven by the same actuator 302 with more adaptability. The finger 400 is adaptive in the sense that as the position of contact (or contact force by an object) changes, different links or members will move. In other words, which member among the proximal member 402 and distal member 408 will move may change depending on the point of contact.

Also, maintaining the end of the cable 420 to be floating in the distal member 408 prevents the cable 416 from breaking or being damaged. Specifically, when the finger 400 gets in contact or pushes other objects, the fact that the cable 416 is floating provides some flexibility and avoids breaking or denting the cable 416. In addition, the use of the torsion springs 434 and 436 provides some stability to the finger system 400, especially when the finger 400 grabs an object or is under some external force. The torsion springs 434 and 436 also prevent anti-backlash.

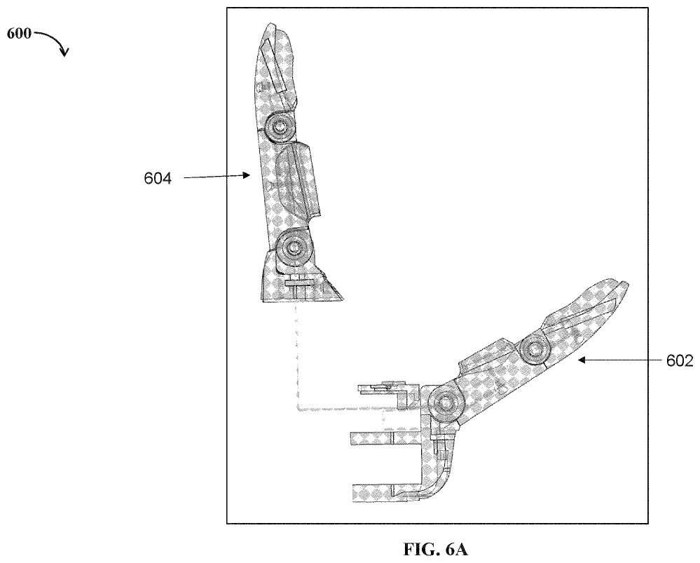

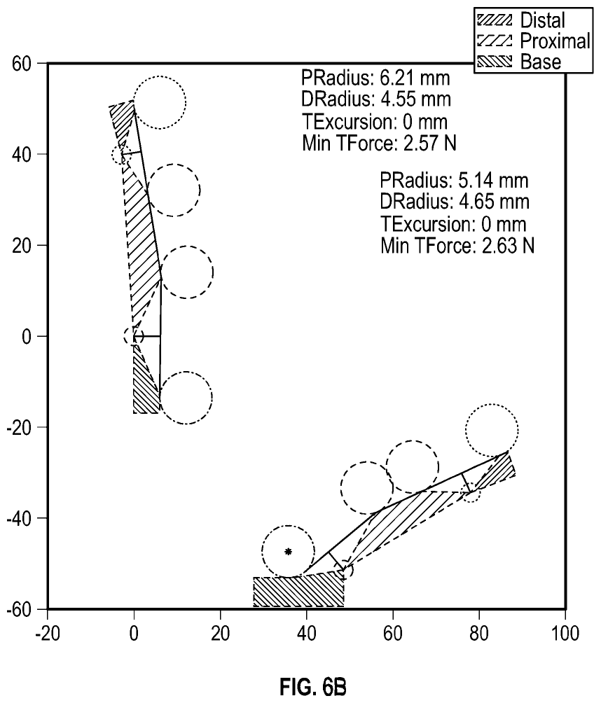

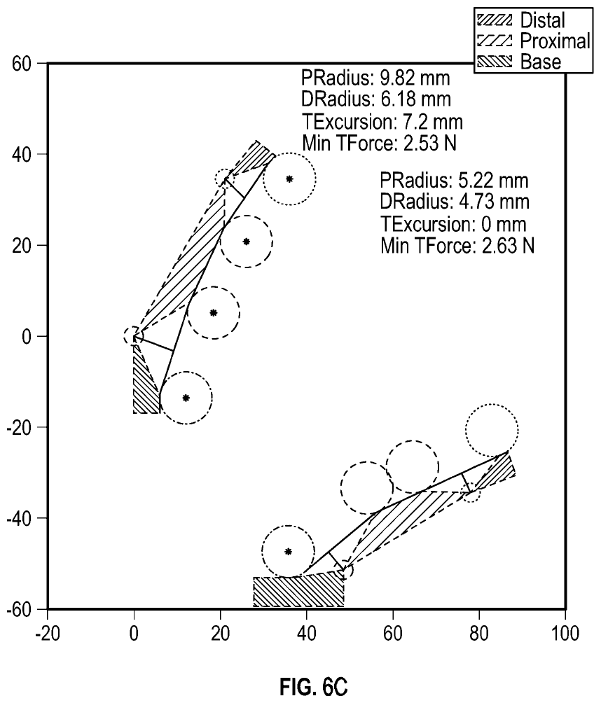

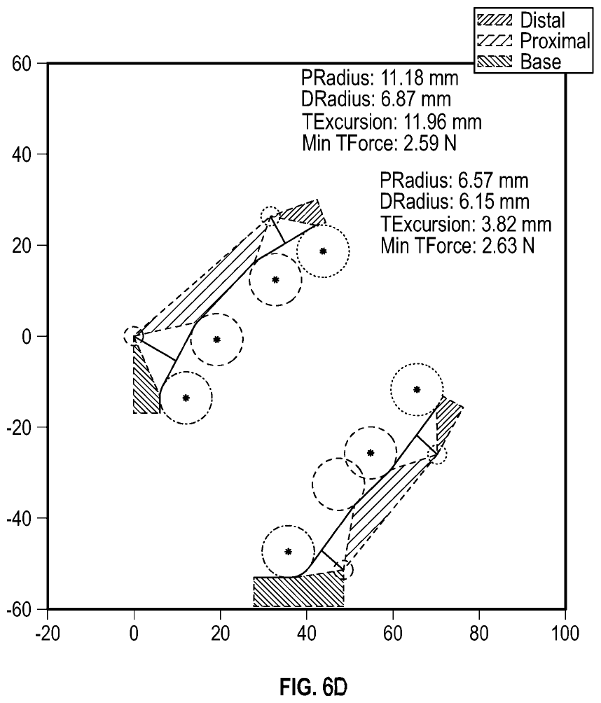

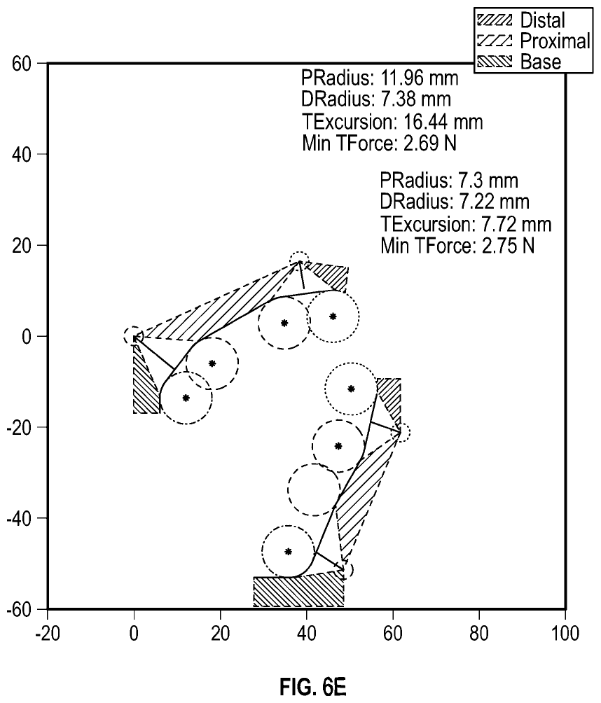

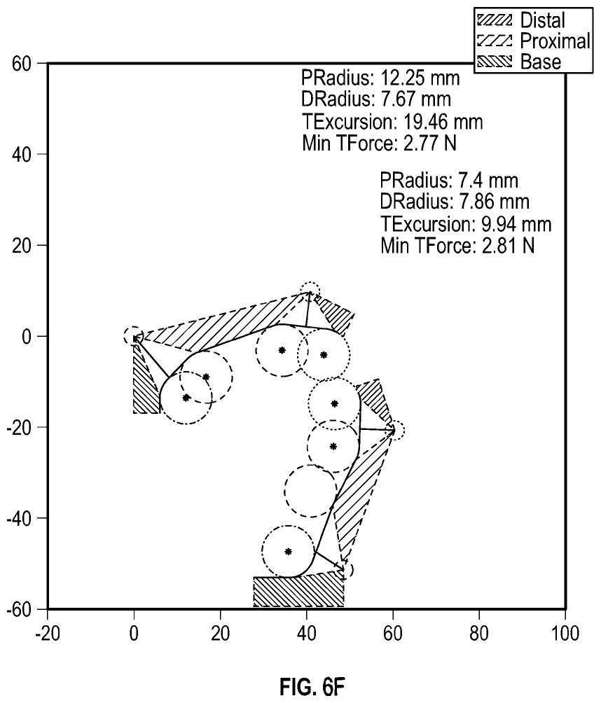

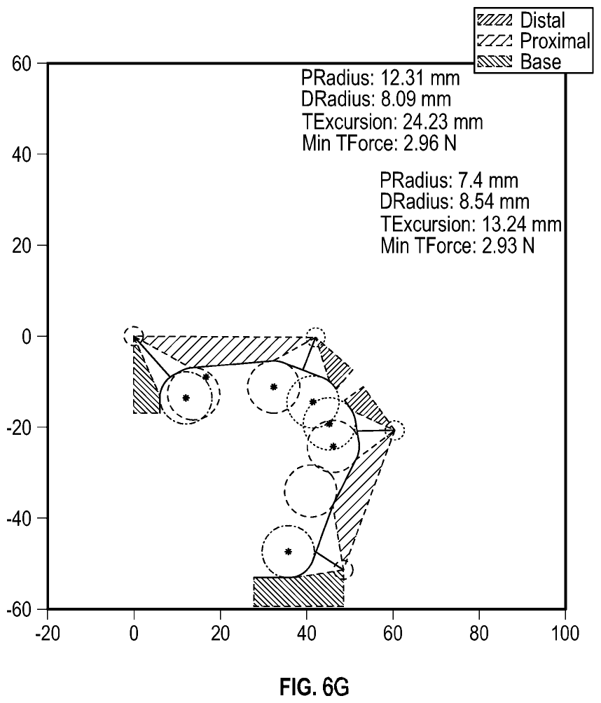

Referring now to FIGS. 6A-6G, motion simulated results for a system 600 including two fingers are shown, according to an example embodiment. FIG. 6A shows a system 600 including a thumb finger 602 and a forefinger 604. FIGS. 6B-6G show sample frames of a video sequence depicting motion of the fingers 602 and 604 towards each other.

As the cables for both fingers 602 and 604 get pulled by the actuator 302 or the gearbox 304, the fingers 602 and 604 move toward each other. The circles shown in FIGS. 6B-6G are indicative of divots (or curved surfaces) in the finger 400 that allows the cable not to bend and also allow to tune the torque. As the fingers 602 and 604 bend, the distances between the corresponding cables (shown in black lines) and corresponding joints increases, implying a changing radius or distance between each joint and the cable. The motion of the proximal member and distal member of each finger indicates that the cable is acting pretty much similar to a tendon in a human finger. Also, the fact that the cable is changing radius (or distance from the joints) helps moving some of the complexity from the gearbox 304 into the finger itself.

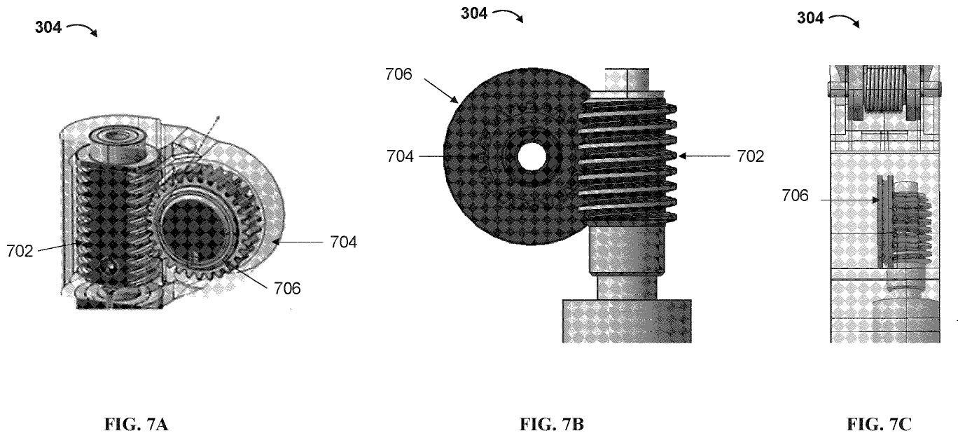

FIGS. 7A-7C show diagrams of a gearbox 304, according to an embodiment. The gearbox 304 can include a gear 702 (e.g., a worm gear) and a worm wheel 704. The gear 702 can be fixed to a shaft of the actuator 302. As the shaft is rotated by a motor, the gear rotates and cause the worm wheel 704 to rotate. The worm wheel 704 can include a pulley 706 and the cable 416 can be connected to the pulley 706. For instance, a portion of the cable 416 can be wrapped around the pulley 706. As the gear 702 rotates, the cable gets pulled or unwrapped from the pulley 706.

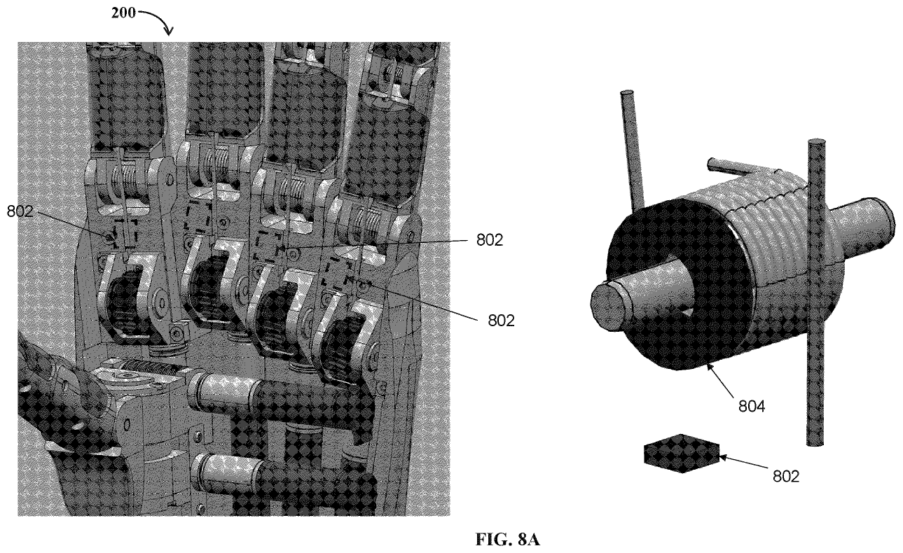

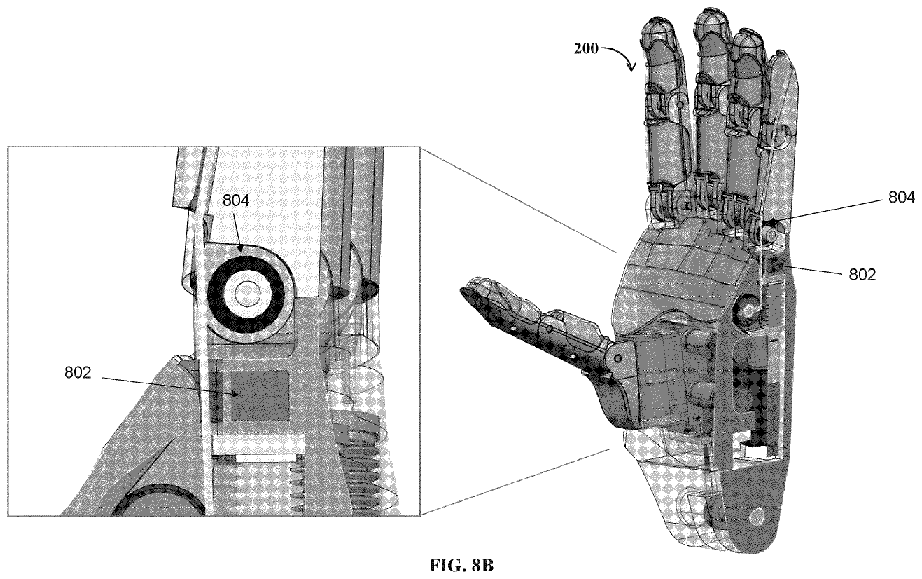

FIGS. 8A and 8B depict the use of hall effect sensors 802 to monitor the position of a finger or the corresponding members, according to an embodiment. A finger, such as finger 400, can include a magnet 804, such as a ring magnet. The magnet 304 can be coupled to the pivot 406 between the proximal member 402 and the palm region 202 (or the base member 438). The finger 400 can include a hall effect sensor 302 placed proximate to the respective magnet 804. For example, the hall effect sensor 803 can be placed or located in the base member 438 or in the palm region 202. The hall effect sensor 802 can sense or measure the magnetic field produced by the magnet 804. As the proximal member 402 rotates, so does the magnet 804. The hall effect sensor 804 does not move with the proximal member 402 and can detect changes in the magnetic field as the proximal member 402 rotates. The hall effect sensor 802 can be communicatively coupled to the processor 114. The processor 114 can determine based on the measured magnetic field the position or angle of rotation of the proximal member 402.

In some implementations, each finger in the hand 200 can include a respective hall effect sensor 802 and a respective magnet 804. In some implementations, a finger 400 (or each finger of hand 200) can include a magnet positioned at or around the pivot 414 and hall effect sensor 802 arranged in the proximal member proximate to magnet 804. The hall effect sensor 802 can be used by the processor 114 to detect a position or rotation angle of the distal member relative to the proximal member 402. In some implementations finger 400 or each finger of hand 200) can include a first hall effect sensor and a first magnet to monitor the position of the proximal member 402, and a second hall effect sensor and a second magnet to monitor the position of the distal member 408 relative to the proximal member 402. In some implementations, the magnet 804 can include a ring magnet placed around the pivot 406 or the pivot 414.

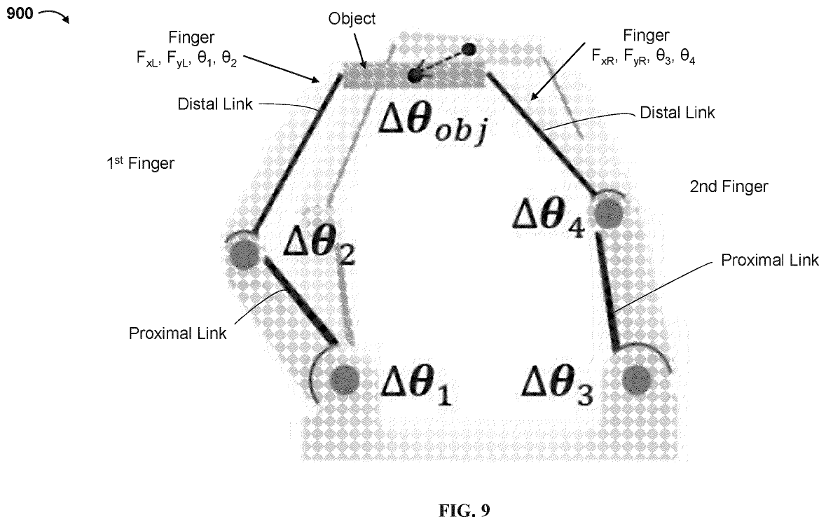

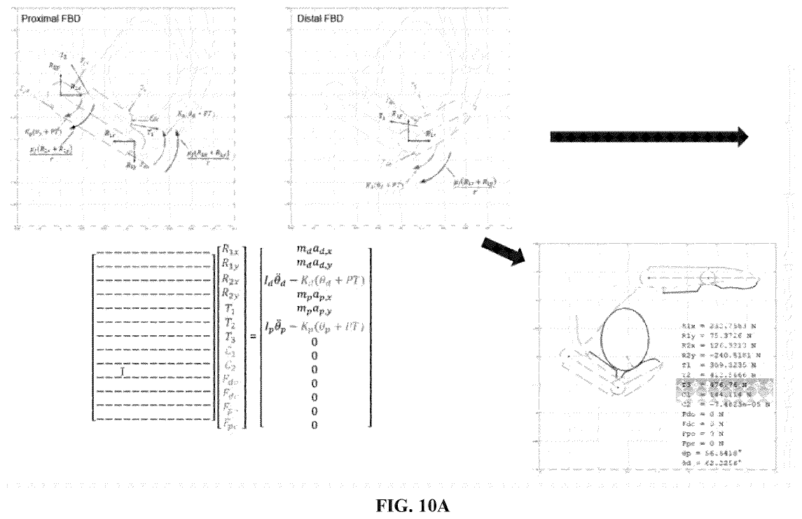

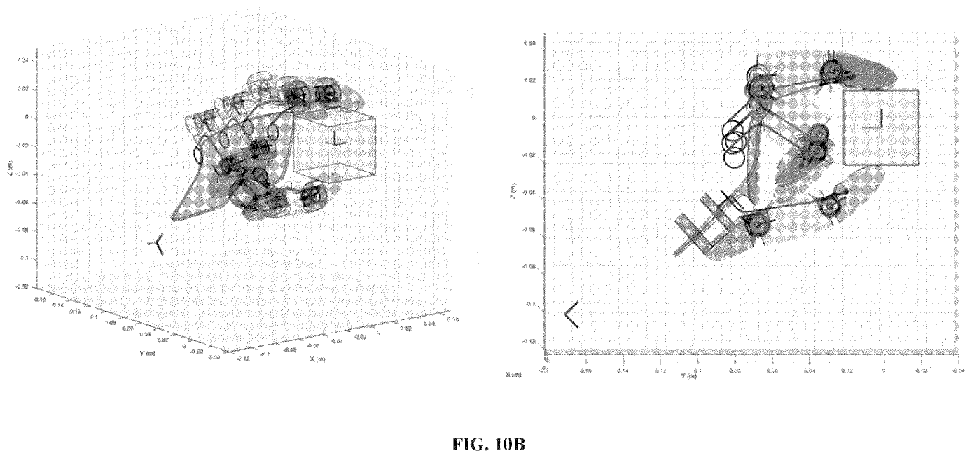

FIG. 9 shows a framework 900 for optimizing the parameters of cable-driven finger, according to an embodiment. The framework includes two fingers and an object grasped (or to be grasped by the two fingers. Each finger can have a corresponding proximal link and a corresponding distal link. Each finger can be driven by a corresponding cable. Each finger exerts a corresponding force on the object.

Adaptive finger mechanisms are inherently unstable. A goal of the optimization is to solve for optimal parameters of the fingers, including finger lengths (e.g., lengths of proximal and distal members of the finger), joint stiffness (e.g., stiffness introduced by corresponding torsion spring), joint locations and cable routings (e.g., distances from joints). The optimization can include minimizing post contact work (e.g., object displacement relative to fingers) and maximizing resistible external forces. Minimizing post contact work means minimizing movement of object relative to the fingers once grasped (e.g., slipping). This is expected to lead to more reliable and stable grasping. Maximizing resistible external forces means maximizing resistance to any external forces after grasping the object. This will prevent or mitigate the chances of the object falling if running into an obstacle, for example.

The forces F_{xL} and F_{yL} represent the forces of the left finger in the x and y axes. The forces F_{xR} and F_{yR} represent the forces of the right finger in the x and y axes. Both forces depend on the location or routing of the cable. The optimization can be performed subject to a set of constraints, such as for equilibriums, torque equilibrium, hand model constraints, closure constraints and/or a kinematic constraint, among other constraints.

In some implementations, grasping a large variety of objects can be modeled or simulated in different positions and a computer system, including a memory and processor, can solve for optimal parameters (e.g., optimal components and component locations). Failure modes can include object ejection, loss of grip and/or loss of stability. Solving the optimization problem can include determining cable location or distance from joints, stiffness of springs and/or lengths of fingers or links thereof.

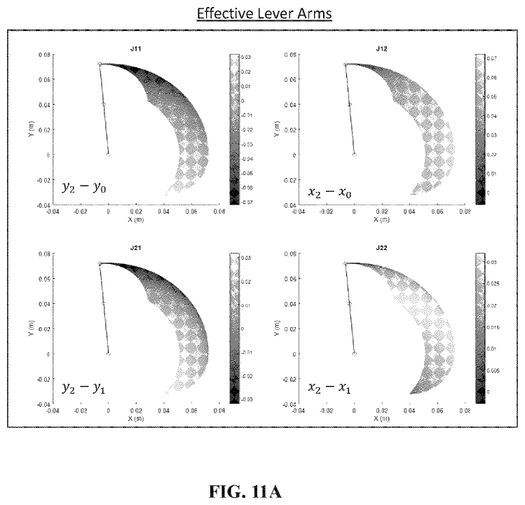

FIGS. 10A and 10B show an optimization model and a simulation od an optimized hand model. In particular, FIG. 10A shows the variables considered for the proximal member and the distal member in the optimization. FIG. 10B shows a simulation of an example hand model with estimated cable position and representative geometry determined by solving the optimization problem by a computer system as depicted in FIG. 10A.

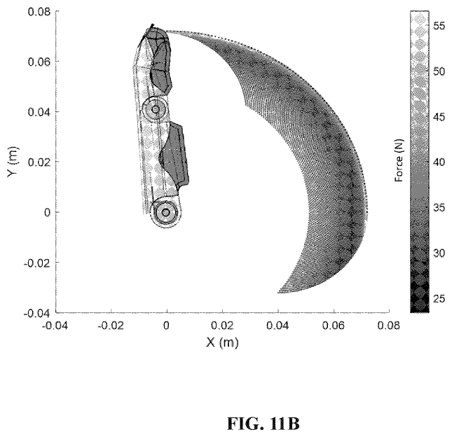

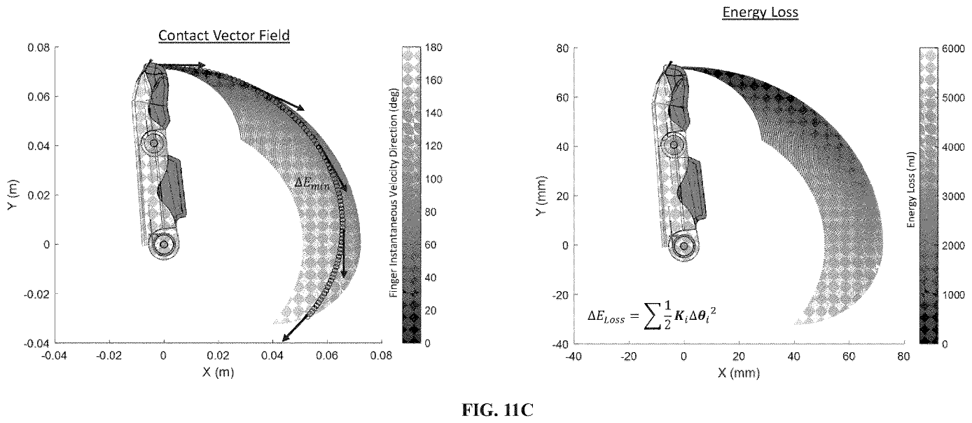

FIGS. 11A-11C show simulation results depicting the effective lever arms, the feasible force range, the contact vector field, and energy loss for an example of the cable-driven finger as described herein.

While embodiments described herein are discussed in relation with a knee joint assembly of a humanoid robot, the embodiments can be used or applied in other types of joints and/or other types of robots.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or a machine-executable instruction may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory, computer-readable, or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitates the transfer of a computer program from one place to another. A non-transitory, processor-readable storage media may be any available media that can be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that can be accessed by a computer or processor. Disk and disc, as used herein, include compact disc (CD), laser disc, optical disc, digital versatile disc (DVD), Blu-ray disc, and floppy disk, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A robotic hand system comprising:
a palm region; and
one or more fingers, each finger comprising:
an actuator device;
a respective proximal member having a first end mechanically coupled to the palm region robot and configured to rotate around a respective first pivot relative to the palm region;
a respective distal member having a first end mechanically coupled to a second end of the proximal member and configured to rotate around a respective second pivot relative to the proximal member; and
a respective cable having a first portion coupled to the actuator and a second portion extending along the proximal member and the distal member, the second portion separated away from the first pivot and the second pivot and having an end with a higher dimension than a diameter of the cable, the end with higher dimension structured to engage the distal member when the cable is pulled by the actuator.

2. The robotic hand system of claim 1, wherein the end with higher dimension is floating within a region of the distal member.

3. The robotic hand system of claim 1, wherein the end with higher dimension includes at least one of:
a potted end; or
an end with a potted insert.

4. The robotic hand system of claim 1, wherein each finger comprises a respective channel structure extending at least partially along the respective proximal member and the respective distal member, the respective channel structure hosting at least partially the second portion of the respective cable.

5. The robotic hand system of claim 4, wherein the end with higher dimension of the second portion of the respective cable is structured to engage a ledge structure of the respective channel structure when the respective cable is pulled by the respective actuator.

6. The robotic hand system of claim 1, wherein each finger comprises:
a respective first torsion spring placed around the respective first pivot; and
a respective second torsion spring placed around the respective second pivot.

7. The robotic hand system of claim 1, wherein each finger comprises:
a respective magnet coupled to the respective first pivot; and
a respective hall effect sensor placed proximate to the respective magnet.

8. The robotic hand system of claim 7, wherein the respective magnet includes a ring magnet placed around the respective first pivot.

9. The robotic hand system of claim 1, wherein each finger comprises:
a respective magnet coupled to the respective second pivot; and
a respective hall effect sensor placed proximate to the respective magnet.

10. The robotic hand system of claim 1, a distance between the respective cable and the respective first pivot varies and/or a distance between the respective cable and the respective second pivot varies.

11. A finger device, comprising:
an actuator device;
a proximal member having a first end mechanically coupled to base member and configured to rotate around a first pivot relative to the base member;
a distal member having a first end mechanically coupled to a second end of the proximal member and configured to rotate around a second pivot relative to the proximal member; and
a cable having a first portion coupled to the actuator and a second portion extending along the proximal member and the distal member, the second portion separated away from the first pivot and the second pivot and having an end with a higher dimension than a diameter of the cable, the end with higher dimension structured to engage the distal member when the cable is pulled by the actuator.

12. The finger device of claim 11, wherein the end with higher dimension is floating within a region of the distal member.

13. The finger device of claim 11, wherein the end with higher dimension includes at least one of:
a potted end; or
an end with a potted insert.

14. The finger device of claim 11, further comprises a channel structure extending at least partially along the proximal member and the distal member, the channel structure hosting at least partially the second portion of the cable.

15. The finger device system of claim 14, wherein the end with higher dimension of the second portion of the cable is structured to engage a ledge structure of the channel structure when the respective cable is pulled by the respective actuator.

16. The finger device of claim q1, further comprises:
a first torsion spring placed around the first pivot; and
a second torsion spring placed around the second pivot.

17. The finger device of claim 11, further comprises:
a magnet coupled to the first pivot; and
a hall effect sensor placed proximate to the magnet.

18. The finger device of claim 17, wherein the magnet includes a ring magnet placed around the first pivot.

19. The finger device system of claim 11, further comprises:
a magnet coupled to the second pivot; and
a hall effect sensor placed proximate to the magnet.

20. The finger device of claim 1, a distance between the cable and the first pivot varies and/or a distance between the cable and the second pivot varies.
